(19) United States
(12) Patent Application Publication
(10) Pub. No.: US 2009/0066520 A1
(43) Pub. Date: Mar. 12, 2009

(54) Transmitting and receiving apparatus according to transcutaneous discrete stimulation of nerve at a plurality of regions and dedicated transmitter for communication

(76) Inventor: Hitomi Shimada, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/230,761

(22) Filed: Sep. 4, 2008

(30) Foreign Application Priority Data
Sep. 10, 2007 (JP) 2007-233602
Jan. 22, 2008 (JP) 2008-011434

(51) Int. Cl. G08B 23/00

(52) U.S. Cl. 340/573.1

(57) ABSTRACT

[Problem to be Solved]

Transmission and reception of signals according to transcutaneous stimulation through nerves.

[Solution]

A transmission means main body T transmits stimulation control signals respectively corresponding to stimulation means 1a, 1b (referring to FIGS. 1 and 2) respectively corresponding to a multi-region nerve stimulation means 1 (referring to FIG. 1) of a nerve stimulation receiver main body 3 (referring to FIG. 1) of a transmitting and receiving apparatus according to transcutaneous discrete stimulation of nerve at a plurality of regions. Each electric switch S for stimulation control signal transmits a corresponding stimulation control signal to the transmission means main body T. An attachment means 5 for transmission is provided so that the above-mentioned respective electric switches Sa, Sb are driven, respectively, at respective prescribed regions 6a, 6b of a human body 6.

### FIELD OF INVENTION

The present invention relating to claim 1 generally relates to a transmitting and receiving apparatus, particularly to a transmitting and receiving apparatus constituted so as to stimulate nerves at a plurality of regions of skin. More particularly, it relates to a transmitting and receiving apparatus allowing discrimination of the difference in the contents of signals by discretely stimulating the nerves at a plurality of regions such as skin of a human body, wherein the signals are characterized by the difference in the contents.

The present invention relating to claim 2 generally relates to a transmission apparatus, particularly a transmitter for a transmitting and receiving apparatus constituted so as to stimulate nerves of a plurality of regions of skin. More particularly, it is for a receiver allowing discrimination of the difference in the contents of the signals by discretely stimulating the nerves of the plurality of regions such as skin of a human body, and relates to a transmitting and receiving apparatus characterized by a transmitter transmitting the difference in the contents as the signals.

### BACKGROUND OF INVENTION

Although there ordinarily exist transmitting and receiving apparatuses, such as those in broadcasting, a portable telephone, and an electronic mail, these are all through visual and auditory senses. Utilization of communication through an organ of sense other than these is contemplated as required. For example, there is a transmitter for communication of signals by transcutaneous stimulation through nerves in communication through the visual and auditory senses when there is an obstacle such as noise or in important communication avoiding tapping to secure secret.

### DISCLOSURE OF INVENTION

### [Problem(s) to be Solved by Invention]

Accordingly, one problem to be solved by the present invention is, for example, that it is impossible for an audio visual handicapped person to communicate by sound waves/light rays. Obviously, there is communication of a simple signal not requiring language. In such cases, utilization of communication by transcutaneous stimulation of nerve is a breakthrough. Accordingly, the above mentioned invention is made. Further, there is a demand for the necessity of a dedicated transmitter for a receiver of the present invention.

### [Means for Solving the Problem]

Hereinafter, detailed concrete constitution of the transmitting and receiving apparatus according to transcutaneous discrete stimulation of nerve at a plurality of regions in accordance with claim 1 of the present invention is described. In the invention, there is provided a multi-region nerve stimulation means. The multi-region nerve stimulation means transcutaneously and discretely stimulates the nerves of a plurality of regions of the skin. Further, there is a nerve stimulation means prescribed region attachment means. The nerve stimulation means prescribed region attachment means mounts the multi-region nerve stimulation means at the prescribed plurality of regions of the skin of the human body. Further, there is a nerve stimulation receiver main body. The nerve stimulation receiver main body transmits signals stimulating the respective nerves to the multi-region nerve stimulation means provided to the nerve stimulation means prescribed region attachment means. Finally, there is a multi-region nerve stimulation signal transmitter. The multi-region nerve stimulation signal transmitter transmits signals for discretely stimulating the nerve at the plurality of regions to the nerve stimulation receiver main body.

Next, detailed concrete constitution of the transmitter for communication according to transcutaneous discrete stimulation of nerve at a plurality of regions in accordance with claim 2 of the present invention is described. In the invention, there is a transmission means main body. The transmission means main body transmits stimulation control signals respectively corresponding to the corresponding stimulation means of the multi-region nerve stimulation means of the nerve stimulation receiver main body of the transmitting and receiving apparatus according to transcutaneous discrete stimulation of nerve at a plurality of regions, and is constituted as described below. Further, there are electric switches for the respective corresponding stimulation control signals. The electric switches for the stimulation control signals transmit the respective corresponding stimulation control signals to the transmission means main body. Further, there is an attachment means for transmission. The attachment means for transmission is provided so that the respective electric switches are driven at the respective prescribed regions of the human body, respectively.

In the transmission means main body, there are respective oscillation circuits. The oscillation circuits are driven by the respective electric switches and oscillate the respective corresponding stimulation control signals. Further, there is an antenna. The antenna transmits the signals from the respective oscillation circuits.

### EFFECT OF INVENTION

In accordance with the transmitter for communication according to transcutaneous discrete stimulation of nerve at the plurality of regions and the dedicated transmitter for communication thus constituted as described above, the above-mentioned problems are solved to generate the substantial advantages effect as follows. Namely, when there is an obstacle such as noise in the communication by the visual and auditory senses, the transcutaneous stimulation of nerve allows transmission of a necessary signal. In addition, in the serious communication and so forth in which tapping is avoided to secure secret, transmission of signal according to transcutaneous stimulation of nerve is allowed. Further, transcutaneous communication to an audio visual handicapped person is allowed. Further, as the dedicated transmitter for the receiver for communication, because the motions of separate respective regions of the body are converted into signals using the electric switches, it is integrated with the receiver, thereby enhancing the effect.

### BEST MODE OF CARRYING OUT INVENTION

In order to solve the above problems, the transmission for communication according to transcutaneous discrete stimulation of nerve at a plurality of regions and the dedicated transmitter for communication are made as the transmitting and receiving apparatus utilizing the transcutaneous stimulation of nerve and the transmitter corresponding to the receiver receiving various kinds of signals. Accordingly, a valid communication means is provided for an audio visual handicapped person for whom communications by sound waves/light rays do not work. Obviously, there are advantages in the communication of a simple signal not requiring a sentence such as those transmitting only directions such as yes or no and right or left that the multi-region nerve stimulation means is simplified.

### EMBODIMENT 1

Accordingly, the transmitting and receiving apparatus according to transcutaneous discrete stimulation of nerve at a plurality of regions according to claim 1 of the present invention is described in detail, using a concrete embodiment thereof, with reference to the accompanying drawings. In the invention, there is a multi-region nerve stimulation means 1. The multi-region nerve stimulation means 1 for transcutaneously and discretely stimulating nerves of a plurality of regions of skin comprises vibrators, paired electrodes, or the like. Accordingly, in the case of the electrodes, accessories such as a set of earrings, bracelets, and wristwatches may be utilized. Further, in the case of the electrodes, when a common electrode is used as one electrode of each of the plurality of electrode pairs, the number of wires is reduced.

Next, there is a nerve stimulation means prescribed region attachment means 2 comprising underwear or the like brought into close contact with skin. The nerve stimulation means prescribed region attachment means 2 attaches the multi-region nerve stimulation means 1 to a plurality of prescribed regions of skin of a human body. In this embodiment, as shown in FIG. 1, an undershirt for marathon running is used for the nerve stimulation means prescribed region attachment means 2, and the multi-region nerve stimulation means 1 is attached to the inside thereof. In this embodiment, two pieces of the nerve stimulation means prescribed region attachment means 2 are illustrated for simplicity in the drawings. The number thereof may be increased as necessary. Thus, a coach can give a number of pieces of advice to the runner. Thus, anything that is directly brought into contact with the body such as shorts, athletic supporter, or the like may be used for the nerve stimulation means prescribed region attachment means 2. Further, the nerve stimulation means prescribed region attachment means 2 may be integrated with the multi-region nerve stimulation means 1. In particular, when the nerve stimulation means prescribed region attachment means 2 is the electrodes, because a metal part of the earring or pierced earring and its metal clasp may be the same, they are easily integrated.

Further, there is a nerve stimulation receiver main body 3. The nerve stimulation receiver main body 3 transmits signals for stimulating the respective nerves to the multi-region nerve stimulation means 1 provided to the nerve stimulation means prescribed region attachment means 2. Finally, there is a multi-region nerve stimulation signal transmitter 4. The multi-region nerve stimulation signal transmitter 4 transmits signals for discretely stimulating the nerves at a plurality of regions to the nerve stimulation receiver main body 3.

Accordingly, as shown in FIG. 2, when the embodiment is constituted so as to include two pieces of the multi-region nerve stimulation means 1, Morse communication is performed, for example, by making the multi-region nerve stimulation means 1a at the left side correspond to a “dot” of a Morse signal and by making the multi-region nerve stimulation means 1b at the right side correspond to a “dash” of the Morse signal. Obviously, when the multi-region nerve stimulation means 1a at the left side corresponds to “YES” and the multi-region nerve stimulation means 1b at the right side corresponds to “NO”, for example, the action of the receiver is thereby normally controlled.

Further, when ten pieces of the multi-region nerve stimulation means 1 are used as those like a ten-key pad of a calculator, a numeral is also transmitted. Further, not only one piece of the multi-region nerve stimulation means 1 is turned on but also all of them are simultaneously subjected to on/off-control, a signal of an exponential number with respect to the multi-region nerve stimulation means 1 is transmitted. An example thereof is shown in FIG. 2. The signals of three states may be transmitted, i.e., the state in which only 1a of the multi-region nerve stimulation means is driven, the state in which only 1b of the multi-region nerve stimulation means is driven, and the state in which both of 1a and 1b of the multi-region nerve stimulation means are driven. Further, when a state in which both of 1a and 1b of the multi-region nerve stimulation means are not driven is included, there are four states.

### EMBODIMENT 2

Accordingly, the transmitting and receiving apparatus according to transcutaneous discrete stimulation of nerve at a plurality of regions according to claim 2 of the present invention is described in detail, using a concrete embodiment thereof, with reference to the accompanying drawings. However, the invention is a dedicated transmitter for a receiver of the above-mentioned Japan patent application number 2007-233602. Thus, the present invention is not understood if it is not understood what the receiver is. Accordingly, the embodiment of that invention is explained first. In the invention, there is a multi-region nerve stimulation means 1. The multi-region nerve stimulation means 1 for transcutaneously and discretely stimulating nerves of a plurality of regions of skin comprises vibrators, paired electrodes, or the like. Accordingly, in the case of the electrodes, accessories such as a set of earrings, bracelets, and wristwatches may be utilized. Further, in the case of the electrodes, when a common electrode is used as one electrode of each of the plurality of electrode pairs, the number of wires is reduced.

Next, there is a nerve stimulation means prescribed region attachment means 2 comprising underwear or the like brought into close contact with skin. The nerve stimulation means prescribed region attachment means 2 attaches the multi-region nerve stimulation means 1 to a plurality of prescribed regions of skin of a human body. In this embodiment, as shown in FIG. 1, an undershirt for marathon running is used for the nerve stimulation means prescribed region attachment means 2, and the multi-region nerve stimulation means 1 is attached to the inside thereof. In this embodiment, two pieces of the nerve stimulation means prescribed region attachment means 2 are illustrated for simplicity in the drawings. The number thereof may be increased as necessary. Thus, a coach can give a number of pieces of advice to the runner. Thus, anything that is directly brought into contact with the body such as shorts, athletic supporter, or the like may be used for the nerve stimulation means prescribed region attachment means 2. Further, the nerve stimulation means prescribed region attachment means 2 may be integrated with the multi-region nerve stimulation means 1. In particular, when the nerve stimulation means prescribed region attachment means 2 is the electrodes, because a metal part of the earring or pierced earring and its metal clasp may be the same, they are easily integrated.

Further, there is a nerve stimulation receiver main body 3. The nerve stimulation receiver main body 3 transmits signals for stimulating the respective nerves to the multi-region nerve stimulation means 1 provided to the nerve stimulation means prescribed region attachment means 2. Finally, there is a multi-region nerve stimulation signal transmitter 4. The multi-region nerve stimulation signal transmitter 4 transmits signals for discretely stimulating the nerves at a plurality of regions to the nerve stimulation receiver main body 3.

Accordingly, as shown in FIG. 2, when the embodiment is constituted so as to include two pieces of the multi-region nerve stimulation means 1, Morse communication is performed, for example, by making the multi-region nerve stimulation means 1a at the left side correspond to a “dot” of a Morse signal and by making the multi-region nerve stimulation means 1b at the right side correspond to a “dash” of the Morse signal. Obviously, when the multi-region nerve stimulation means 1a at the left side corresponds to “YES” and the multi-region nerve stimulation means 1b at the right side corresponds to “NO”, for example, the action of the receiver is thereby normally controlled.

Further, when ten pieces of the multi-region nerve stimulation means 1 are used as those like a ten-key pad of a calculator, a numeral is also transmitted. Further, not only one piece of the multi-region nerve stimulation means 1 is turned on but also all of them are simultaneously subjected to on/off-control, a signal of an exponential number with respect to the multi-region nerve stimulation means 1 is transmitted. An example thereof is shown in FIG. 2. The signals of three states may be transmitted, i.e., the state in which only 1a of the multi-region nerve stimulation means is driven (A of FIG. 2), the state in which only 1b of the multi-region nerve stimulation means is driven (B of FIG. 2), and the state in which both of 1a and 1b of the multi-region nerve stimulation means are driven (C of FIG. 2). Further, when a state in which both of 1a and 1b of the multi-region nerve stimulation means are not driven (D of FIG. 2) is included, there are four states.

### EMBODIMENT 3

Accordingly, the transmitter for communication according to transcutaneous discrete stimulation of nerve at a plurality of regions according to the present invention is described in detail, using a concrete embodiment thereof, with reference to the accompanying drawings. In the invention, as shown in FIG. 3, there is a transmitting means main body T. The transmitting means main body T transmits stimulation control signals respectively corresponding to stimulation means 1a, 1b (referring to FIGS. 1 and 2) respectively corresponding to a multi-region nerve stimulation means (referring to FIG. 1) 1 of a nerve stimulation receiver main body 3 (referring to FIG. 1) of a transmitting and receiving apparatus according to transcutaneous discrete stimulation of nerve at a plurality of regions, and constituted as described below. Next, there are electric switches S for the respective corresponding stimulation control signals. The electric switches S for the stimulation control signals transmit the respective corresponding stimulation control signals to the transmission means main body T. Namely, they each operate corresponding to each, for example, when a certain electric switch Sa is turned on, the corresponding stimulation signal is transmitted, and the corresponding stimulation means 1a is drive. When another electric switch Sb is turned on, the corresponding stimulation signal is transmitted, and the corresponding stimulation means 1b is driven, and so forth.

Finally, there is an attachment means 5 for transmission. The attachment means 5 for transmission is provided so that the respective electric switches Sa, Sb are driven at the respective prescribed regions 6a, 6b of the human body 6, respectively. Accordingly, regions such as right and left parts of limbs which are mobile and easily distinguished are preferred, although the prescribed regions 6a, 6b of the human body 6 are not specifically limited. The attachment means 5 for transmission is not limited to a type such as a band of a wristwatch in which the electric switches S thereof are attached to the body. For example, those gripped by a hand such as a grip-shaped case may be used.

Accordingly, in the transmission means main body T, there are respective oscillation circuits 7. The oscillation circuits 7 are driven by the respective electric switches S and oscillate the corresponding stimulation control signals. Further, there is an antenna 8. The antenna 8 transmits the signals from the respective oscillation circuits.

### EMBODIMENT 4

Similar to the multi-region nerve stimulation means 1 as explained with reference to FIG. 2, when the electric switches Sa, Sb are constituted so as to include two electric switches Sa, Sb as shown in FIG. 4, Morse communication is performed, for example, by making the electric switch Sa at the left side correspond to a “dot” of a Morse signal and by making the electric switch Sb at the right side correspond to a “dash” of the Morse signal. Obviously, when the electric switch Sa at the left side corresponds to “YES” and the electric switch Sb at the right side corresponds to “NO”, for example, the action of the receiver is thereby normally controlled.

Further, when ten electric switches S are used as those like a ten-key pad of a calculator, a numeral is also transmitted. Further, not only one of the electric switches S is turned on but also all of them are simultaneously subjected to on/off-control, a signal of an exponential number with respect to the electric switches S is transmitted. An example thereof is shown in FIG. 4. The signals of three states may be transmitted, i.e., the state in which only the electric switch Sa thereof is turned on (FIG. 4A), the state in which only the electric switch Sb thereof is turned on (FIG. 4B), and the state in which both of the electric switches Sa and Sb thereof are turned on (FIG. 4C). Further, when a state in which both of the electric switches Sa and Sb thereof are not driven is included (FIG. 4D), there are four states.

### EMBODIMENT 5

Accordingly, electrodes in which the above-mentioned switches S are attached to the skin of the surface of the human body (there is a case in which they are attached thereto not directly but through thin texture such as stockings) are used as a multi-region surface myogenic potential sensing switch means which transcutaneously and discretely senses faint electric currents transmitted from the nerves controlling muscles of the plurality of regions, i.e. “the surface myogenic potentials” and which turns on/off the switches S when their outputs exceed a prescribed threshold. Further, an apparatus which senses the surface myogenic potentials and which turns on/off switches when their outputs exceed a prescribed threshold comes into practical use as a myoelectric hand. A powered suit will comes into practical use soon.

An external muscle pressure sensing switch means is made, that senses an electric potential difference of woven/knit fabric, rubber-made cushion or the like which is attached to the skin of the surface of the human body (there are some cases in which it is attached thereto through a thin texture such as stockings), which is in an energized state (containing carbon particles or the like), and to which pressure is applied by muscles and that turns on/off the switch means S by its output exceeding a specific threshold. This external muscle pressure sensing switch means may be substituted for the surface myogenic potential sensing switch means. Accordingly, a surface myogenic potential sensing switch means prescribed region attachment means is made, which attaches the multi-region surface myogenic potential sensing switch means at a plurality of prescribed regions on the skin of the human body. Alternatively, a switch means prescribed region attachment means is made, which attaches the external muscle pressure sensing switch means at a plurality of prescribed regions on the skin of the human body. Thus, a computer means is provided, which edits respective on/off signals transmitted from the multi-region surface myogenic potential sensing switch means provided to the surface myogenic potential sensing switch means prescribed region attachment means, and the transmitting and receiving apparatus according to transcutaneous discrete surface myogenic potential utilizing the multi-region surface myogenic potentials characterized by comprising a wireless or wired transmitter main body transmitting the edited signals is made.

Alternatively, a computer means is made, which edits the respective on/off signals transmitted from the multi-region external muscle pressure sensing switch means provided to the external muscle pressure sensing switch means prescribed region attachment means. The transmitting and receiving apparatus according to transcutaneous discrete external muscle pressure utilizing the multi-region external muscle pressures characterized by comprising a wireless or wired transmitter main body transmitting the edited signals may also be made.

Further, a device may be attached, which receives the edited signals before the wireless/wired transmission or simultaneously with the transmission by means of “the transmitting and receiving apparatus according to transcutaneous discrete stimulation of nerve at a plurality of regions”. In the editing means, the turning-on of the switch S at a certain specific region is transmitted as a long signal and the turning-on of another specific region is transmitted as a short signal, in which the waveform and the time are determined. Further, the signal having the long-on time and the signal having the short-on time of the switch means S at respective regions are discriminated as the long signal and the short signal and are edited as the long/short signals within the determined the waveform and the time.

In remote medical treatment of a patient or remote monitoring of a patient, when the device is made so that a medical operator or a monitoring operator senses a signal transmitted from the body motion of the patient through cutaneous nerves of his/her own body, the significance of invention is drastically enhanced. It is of great significance to remotely sense the motion of the patient at any time and anywhere from a standpoint the same as the patient while also performing medical operations for another patient, not by a visual computer screen or an aural telephone.

### INDUSTRIAL APPLICABILITY

The original applicability for a novel field in communication such as transcutaneous transmission of signal to an audio visual handicapped person, as well as the applicability for a field in transcutaneous electrotherapy, is developed by making the multi-region nerve stimulation means 1 as the electrodes.

### BRIEF DESCRIPTION OF DRAWINGS

FIG. 1 is a plan view of a transmitting and receiving apparatus according to transcutaneous discrete stimulation of nerve at a plurality of regions according to an embodiment of the present invention.

FIG. 2 is a view illustrating an enlarged plan view of the multi-region nerve stimulation means of FIG. 1 in which “A” denotes a state in which only “a” of the stimulation means is driven, “B” denotes a state in which only “b” of the stimulation means is driven, and “C” denotes a state in which both “a” and “b” of the stimulation means are driven. Further, “D” denotes a state in which both of the “a” and “b” of the stimulation means are not driven.

FIG. 3 is a perspective view illustrating an embodiment of the transmitting and receiving apparatus according to transcutaneous discrete stimulation of nerve at a plurality of regions corresponding to the present invention, in which a part thereof is illustrated as a circuit.

FIG. 4 is a view illustrating an enlarged wiring diagram of the electric switch of FIG. 3 in which “A” denotes a state in which only “a” of the electric switch is driven, “B” denotes a state in which only “b” of the electric switch is driven, and “C” denotes a state in which both “a” and “b” of the electric switches are driven. Further, “D” denotes a state in which both of the “a” and “b” of the electric switches are not driven.

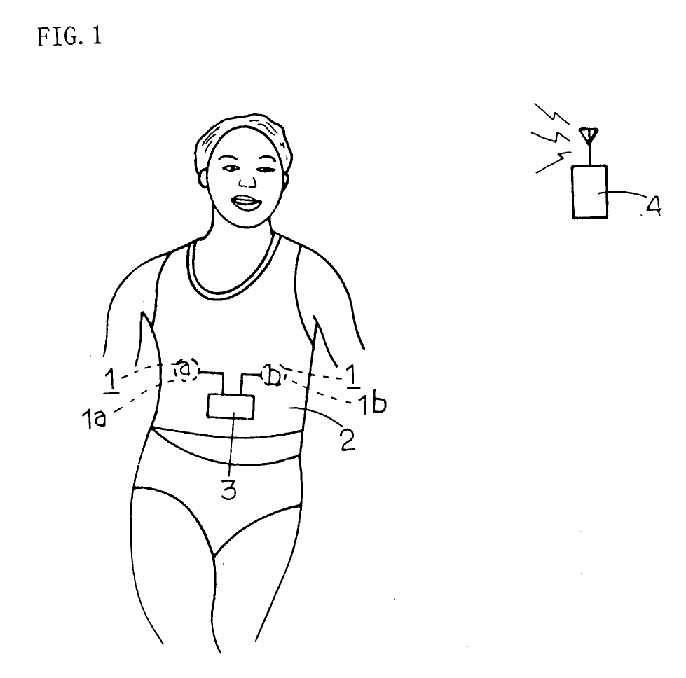

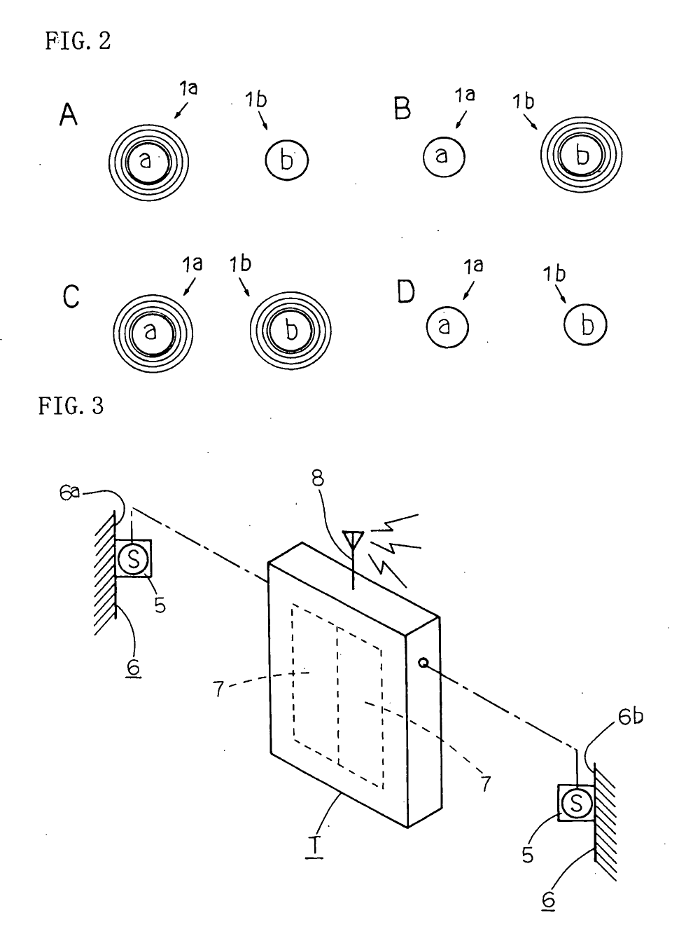

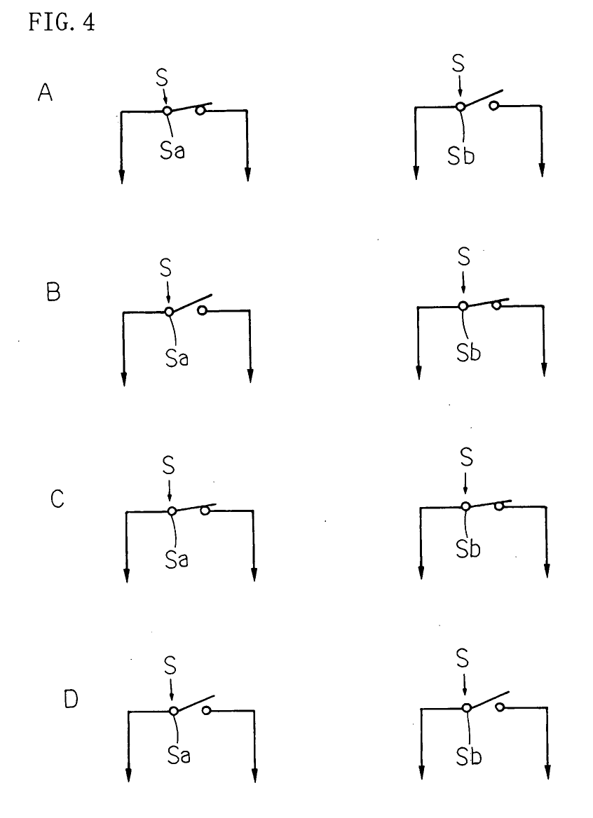

### EXPLANATION OF REFERENCE NUMERALS

1, 1a, 1b multi-region nerve stimulation means
2 nerve stimulation means prescribed region attachment means
3 nerve stimulation receiver main body
4 multi-region nerve stimulation signal transmitter
5 attachment means for transmission
6 human body
6a, 6b prescribed regions
7 oscillation circuit
8 antenna
S, Sa, Sb electric switches
T transmission means main body

What is claimed is:

1. A transmitting and receiving apparatus according to transcutaneous discrete stimulation of nerve at a plurality of regions, characterized by comprising:
a multi-region nerve stimulation means for transcutaneously and discretely stimulating nerves of a plurality of regions of skin;
a nerve stimulation means prescribed region attachment means for attaching the multi-region nerve stimulation means at a plurality of prescribed regions of the skin of a human body;
a nerve stimulation receiver main body transmitting signals for stimulating the respective nerves to the multi-region nerve stimulation means provided to the nerve stimulation means prescribed region attachment means;
and a multi-region nerve stimulation signal transmitter transmitting signals for transcutaneously and discretely stimulating the multi-region nerve stimulation means at the plurality of regions to the nerve stimulation receiver main body.

2. A dedicated transmitter for communication according to transcutaneous discrete stimulation of nerve at a plurality of regions, characterized by comprising:
a transmission means main body which transmits stimulation control signals respectively corresponding to stimulation means respectively corresponding to a multi-region nerve stimulation means of a nerve stimulation receiver main body of a transmitting and receiving apparatus according to transcutaneous discrete stimulation of nerve at a plurality of regions and which is constituted as described below;
electric switches for the respective corresponding stimulation control signals, wherein the electric switches transmit the respective corresponding stimulation control signals to the transmitting means main body;
and an attachment means for transmission provided so that the electric switches are driven, respectively, at respective prescribed regions of a human body.
The transmission means main body comprises respective oscillation circuits driven by the respective electric switches and oscillating the respective corresponding stimulation control signals and an antenna transmitting the signals from the oscillation circuits.
